(19) United States
(12) Patent Application Publication
(10) Pub. No.: US 2023/0109970 A1
(43) Pub. Date: Apr. 13, 2023

(54) MODULAR EYEGLASSES

(71) Applicant: Dartangnan Walker, Inglewood, CA (US)

(72) Inventor: Dartangnan Walker, Inglewood, CA (US)

(21) Appl. No.: 18/078,954

(22) Filed: Dec. 10, 2022

Related U.S. Application Data
(63) Continuation-in-part of application No. 17/335,971, filed on Jun. 1, 2021.
(60) Provisional application No. 63/032,494, filed on May 29, 2020.

(51) Int. Cl. G02C 5/14; G02C 5/22

(52) U.S. Cl. CPC G02C 5/146; G02C 5/22; G02C 2200/06

(57) ABSTRACT

The embodiments disclose a modular eyeglasses apparatus including a first and second temple interchangeably lockable to a first and second eyeglasses frame end, a first and second temple lockable receiver coupled to the first and second eyeglasses frame end, a lockable lever device coupled to the receiver having a lever handle having an upward angled section at one end and having an oblong section at the opposite end, an insertable section at one end of the first and second temple having a semi-circular depression configured to accept an elongated portion of the oblong section, rotating the lever handle downward toward the temple places the elongated portion into the depression to create a friction based coupling to lock the temple in an inserted position, and rotating the lever handle upward away from the temple retracts the elongated portion out of the depression to unlock the temple for removal from the receiver.

### CROSS-REFERENCED TO RELATED APPLICATIONS

This patent application is a continuation-in-part application based on pending U.S. Non-Provisional patent application Ser. No. 17/335,971 filed Jun. 1, 2021, entitled “MODULAR EYEGLASSES”, by Dartangnan Walker, the U.S. patent application being incorporated herein by reference, and U.S. Provisional Patent Application Ser. No. 63/032,494, filed on May 29, 2020, entitled “MODULAR EYEGLASSES”, by Dartangnan Walker, the U.S. patent application being incorporated herein by reference.

### BACKGROUND

Eyewear is known to be a prominent fashion accessory for many individuals the world over. Sunglasses provide the critical function of protecting the wearer from glare from the sun, as well as eye damage. Similarly, prescription corrective lenses ensure that the wearer can see clearly. However, the frames for eyewear are rather expensive, which is notable for both prescription lenses as well as non-prescription lenses. This is especially true for quality eyewear that includes anti-glare coatings, polarization, and scratch-prevention coatings which quickly increase the price of the eyewear.

As such, many individuals only have one or two pairs of glasses. For example, an individual may own one expensive pair of sunglasses and one cheaper pair to at least provide some selection of styling choice. In the case of prescription glasses, a majority of users only own a single pair due to the cost of frames and lenses combined. Many individuals wish to possess more style varieties at their disposal, but the cost to purchase and maintain a wide variety of eyewear in an assortment of colors, textures, and styles is cost prohibitive. If there were a way in which a single set of lens frames could be altered at-will by the user to augment the style of the eyewear, individuals could possess more choices in their desired style and color of eyewear.

### FIELD OF THE PRESENT INVENTION

The present invention relates to the field of eye wear, and more specifically relates to a modular eyeglasses framework configured to facilitate the rapid customization of eyeglasses components via the quick and easy exchange of eyeglass components via an arm-based quick-release mechanism.

### BRIEF DESCRIPTION OF THE DRAWINGS

FIG. 1 shows for illustrative purposes only an example of an apparatus of the present invention as seen from the side of one embodiment.

FIG. 2 shows for illustrative purposes only an example of a view of the apparatus of the present invention as seen from the front of one embodiment.

FIG. 3 shows a block diagram of an overview flow chart detailing the process of use of the present invention by a user of one embodiment.

FIG. 4 shows for illustrative purposes only an example of multiple eyeglass temple styles of one embodiment.

FIG. 5 shows a block diagram of an overview of an augmented reality module of one embodiment.

FIG. 6A shows for illustrative purposes only an example of a right arm of one embodiment.

FIG. 6B shows for illustrative purposes only an example of left arm hooks of one embodiment.

FIG. 7A shows for illustrative purposes only an example of left arm hooks unengaged of one embodiment.

FIG. 7B shows for illustrative purposes only an example of left arm hooks engaged of one embodiment.

FIG. 8 shows for illustrative purposes only an example of a find my glasses app of one embodiment.

FIG. 9A shows for illustrative purposes only an example of a trigger connector of one embodiment.

FIG. 9B shows for illustrative purposes only an example of a trigger connector installed of one embodiment.

FIG. 10A shows for illustrative purposes only an example of trigger connector hooks engaged of one embodiment.

FIG. 10B shows for illustrative purposes only an example of trigger connector hooks unengaged of one embodiment.

FIG. 11A shows for illustrative purposes only an example of a trigger connector of one embodiment.

FIG. 11B shows for illustrative purposes only an example of levers of one embodiment.

FIG. 11C shows for illustrative purposes only an example of an arm section of one embodiment.

FIG. 12A shows for illustrative purposes only an example of a temple insertion terminus of one embodiment.

FIG. 12B shows for illustrative purposes only an example of a temple friction dimple of one embodiment.

FIG. 12C shows for illustrative purposes only an example of a temple friction dimple reverse side of temple view of one embodiment.

FIG. 12D shows for illustrative purposes only an example of a temple insertion terminus profile of one embodiment.

FIG. 13A shows for illustrative purposes only an example of a temple insertion terminus with a locking lever in an unlocked position of one embodiment.

FIG. 13B shows for illustrative purposes only an example of a temple friction dimple with a locking lever in a locked position of one embodiment.

FIG. 13C shows for illustrative purposes only an example of a temple friction dimple profile with locked lever of one embodiment.

FIG. 14A shows for illustrative purposes only an example of a temple insertion terminus with a friction channel of one embodiment.

FIG. 14B shows for illustrative purposes only an example of a right side temple friction channel reverse side of temple view of one embodiment.

FIG. 14C shows for illustrative purposes only an example of a temple friction channel profile with locked lever of one embodiment.

### SUMMARY OF THE PRESENT INVENTION

The present invention is a modular eyewear apparatus and system configured to enable the on-the-go exchange of components of the apparatus to facilitate a rapid change of appearance and style of the eyewear at the discretion of the user. The preferred embodiment of the present invention is equipped with a quick-release hook mechanism disposed within sockets of the frame which enable the connection and subsequent disconnection of compatible arms to the frame. As such, the arms are equipped with a mirrored opposite hook configured to connect to the hook of the socket of the frame to ensure a firm connection.

### DETAILED DESCRIPTION OF THE INVENTION

In a following description, reference is made to the accompanying drawings, which form a part hereof, and in which is shown by way of illustration a specific example in which the invention may be practiced. It is to be understood that other embodiments may be utilized and structural changes may be made without departing from the scope of the present invention.

### General Overview:

It should be noted that the descriptions that follow, for example, in terms of modular eyeglasses are described for illustrative purposes and the underlying system can apply to any number and multiple types of eyewear. In one embodiment of the present invention, the modular eyeglasses can be configured using electronic devices. The modular eyeglasses can be configured to include a top mounted lever and can be configured to include a bottom mounted lever using the present invention. The terms “arm” and “temple” are used herein without any change in meaning to refer to the side pieces of the eyewear that extend from the frame and rest on the ears. The terms “trigger” and “lever” refer to the elongated device to lock and unlock the temple or arm to the eyewear frame without any change to the meaning. The terms “dimple” and “recess” and “depression” refer to the semi-circular lower surface section of the insertable section to lock and unlock the temple or arm to the eyewear frame without any change to the meaning.

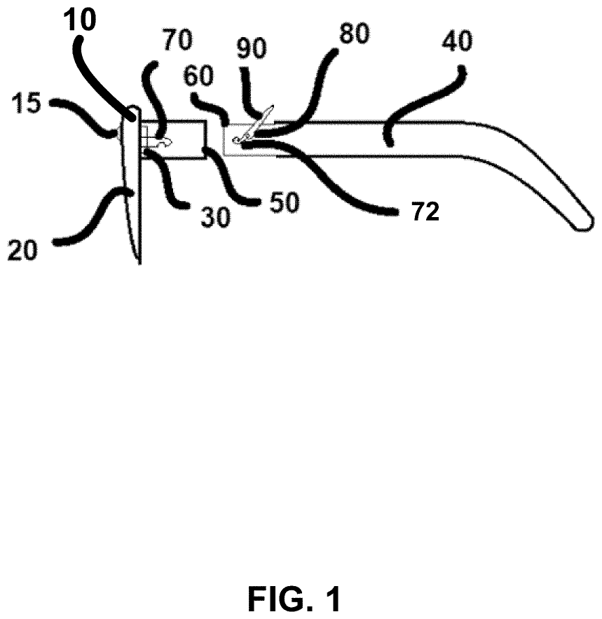

FIG. 1 shows for illustrative purposes only an example of an apparatus of the present invention as seen from the side of one embodiment. FIG. 1 shows an eyeglasses frame 10 with lenses 20. The eyeglasses arms 40 are connected with screws 15 that attach hinges 30 to the frame which facilitates conventional folding of the arms. The arms are held in position via sockets 80 disposed behind the hinges 30 in line with the arms 40. In one embodiment the sockets 80 are coupled to each end of the eyeglasses frame with hinges. The sockets are hollowed and contain locking mechanisms. The hollowed section interior dimensions match the exterior reduced dimensions of the distal end insertable section. The distal end insertable section includes a semi-circular recess with a predetermined length and depth. The removable locking mechanisms include a semi-circular curved portion with an extended lever. The lever is exposed in a lifted unlocked position to enable the user to insert the distal end into the hollowed opening of the socket. After insertion the user presses the lever downward to rotate and position the semi-circular curved portion with the same width and length of the recess into the recess. The semi-circular curved portion fills the depth of the recess with pressure being applied to prevent the arm from inadvertently being withdrawn. When the user lifts the lever the semi-circular curved portion is rotated about a pivot pin and disengages from the recess allowing the arm to be withdrawn from the socket.

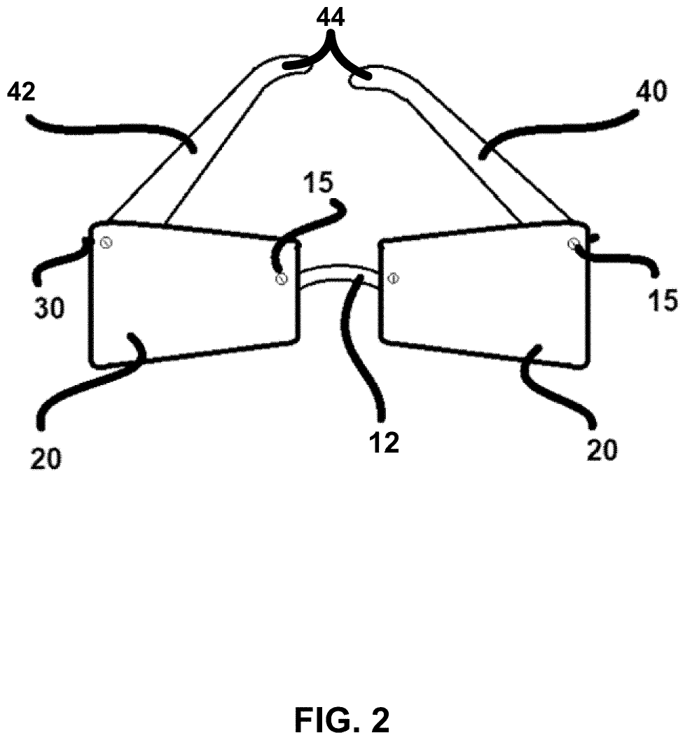

In another embodiment both the sockets 50 as well as the male portions 60 are equipped with hooks. The frame hook 70 of the male portion 60 of each arm 40 is configured to pivot about a pivot point 80. The arm hook 70 of the arm 40 is a mirrored and opposite image of the frame hooks 70 of the socket 50. As such, the arm hook 72 of the arm 40 is configured to securely interlock with the frame hook 70 of the socket 50 upon connection of the male portion 60 of the arm 40 to the socket 50 of the frame 10. A lever 90 is present in communication with the pivot point 80 and arm hook 72 of each arm 40 of the system and apparatus of the present invention as shown in FIG. 2. The lever 90 facilitates the connections and disconnections of the arms 40 to the frame 10 via the socket 50 and male portion 60 of each of the iterations of the modular arms of the present invention of one embodiment.

### DETAILED DESCRIPTION

FIG. 2 shows for illustrative purposes only an example of a view of the apparatus of the present invention as seen from the front of one embodiment. FIG. 2 shows a modular eyewear system and apparatus configured to enable the rapid and easy exchange of components of the apparatus at the will of the user in accordance with the style desired by the user at any given time. The preferred embodiment of the present invention includes a frame 10 containing lenses 20. Alternatively, the frame 10 may be connected to the lenses 20 via screws 12. The frame 10 preferably includes a bridge 12. Adjacent to the lenses 20, hinges 30 are present which facilitate the conventional folding of a pair of arms 44, consisting of a right arm 42 and a left arm 40 which are held in position via sockets 50 (not shown) disposed behind the hinges 30 in line with the arms 44 themselves as shown in FIG. 1. The sockets 50 of the frame 10 are configured to accept a male portion 60 of arms 44 of the apparatus of one embodiment.

### Process of Use:

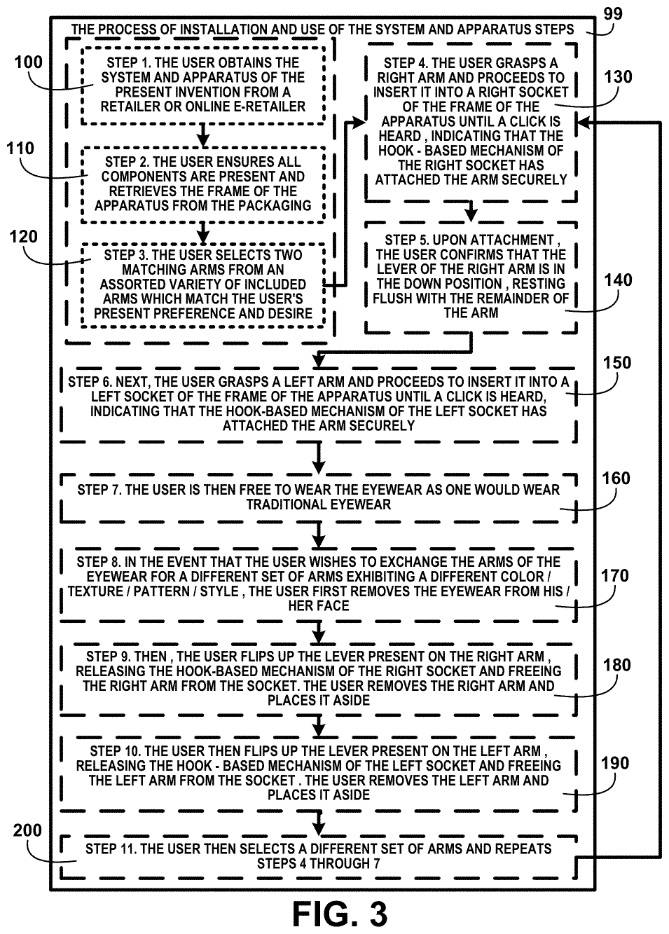

FIG. 3 shows a block diagram of an overview flow chart detailing the process of use of the present invention by a user of one embodiment. FIG. 3 shows a process of installation and use of the system and apparatus steps 99 is preferably as follows. Step 1. The user obtains the system and apparatus of the present invention from a retailer or online e-retailer 100. Step 2. The user ensures all components are present and retrieves the frame of the apparatus from the packaging 110. Step 3. The user selects two matching arms from an assorted variety of included arms which match the user's present preference and desire 120.

Step 4. The user grasps a right arm and proceeds to insert it into a right socket of the frame of the apparatus until a click is heard, indicating that the hook-based mechanism of the right socket has attached the arm securely 130. Step 5. Upon attachment, the user confirms that the lever of the right arm is in the down position, resting flush with the remainder of the arm 140. Step 6. Next, the user grasps a left arm and proceeds to insert it into a left socket of the frame of the apparatus until a click is heard, indicating that the hook-based mechanism of the left socket has attached the arm securely 150. Step 7. The user is then free to wear the eyewear as one would wear traditional eyewear 160.

Step 8. In the event that the user wishes to exchange the arms of the eyewear for a different set of arms exhibiting a different color/texture/pattern/style, the user first removes the eyewear from his/her face 170. Step 9. Then, the user flips up the lever present on the right arm, releasing the hook-based mechanism of the right socket and freeing the right arm from the socket. The user removes the right arm and places it aside 180. Step 10. The user then flips up the lever present on the left arm, releasing the hook-based mechanism of the left socket and freeing the left arm from the socket. The user removes the left arm and places it aside 190. Step 11. The user then selects a different set of arms and repeats steps 4 through 7 200 of one embodiment.

### Multiple Eyeglass Arms Styles:

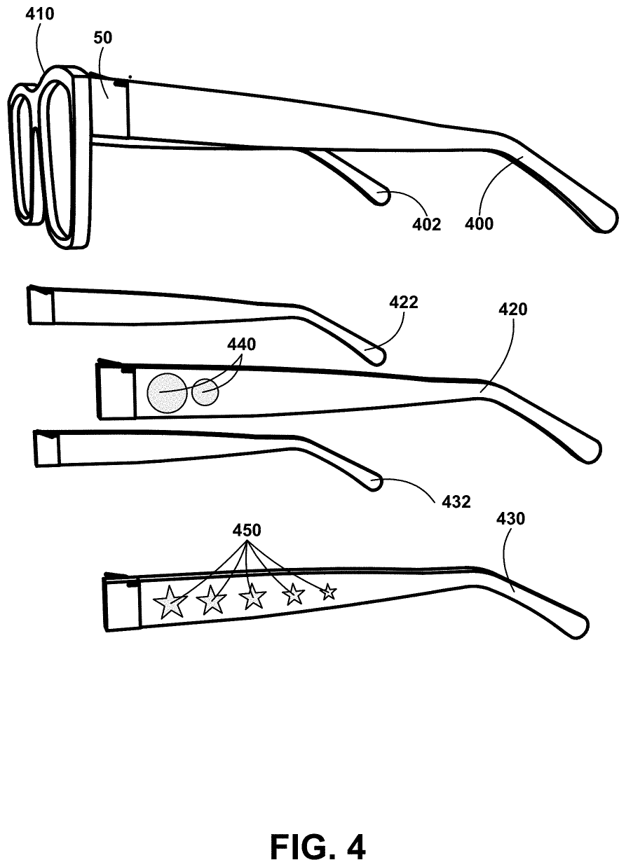

FIG. 4 shows for illustrative purposes only an example of multiple eyeglass arms styles of one embodiment. FIG. 4 shows multiple eyeglass arms styles the user may change to for a new look. The eyeglasses frame with lenses 410 includes the sockets 50 into which the male portion 60 of FIG. 1 inserts. Style no. 1 left arm 400 and style no. 1 right arm 402 as shown installed into the eyeglasses frame with lenses 410. The user can for example quickly change arms to a style no. 2 440 left arm 420 and style no. 2 right arm 422. Decorative embellishments are shown on style no. 2 440 left arm 420. Decorative ornamentation is show on style no. 3 450 left arm 430. For example, the user can change quickly if going to a social function to style no. 3 450 left arm 430 and style no. 3 450 right arm 432 of one embodiment.

### Augmented Reality Module:

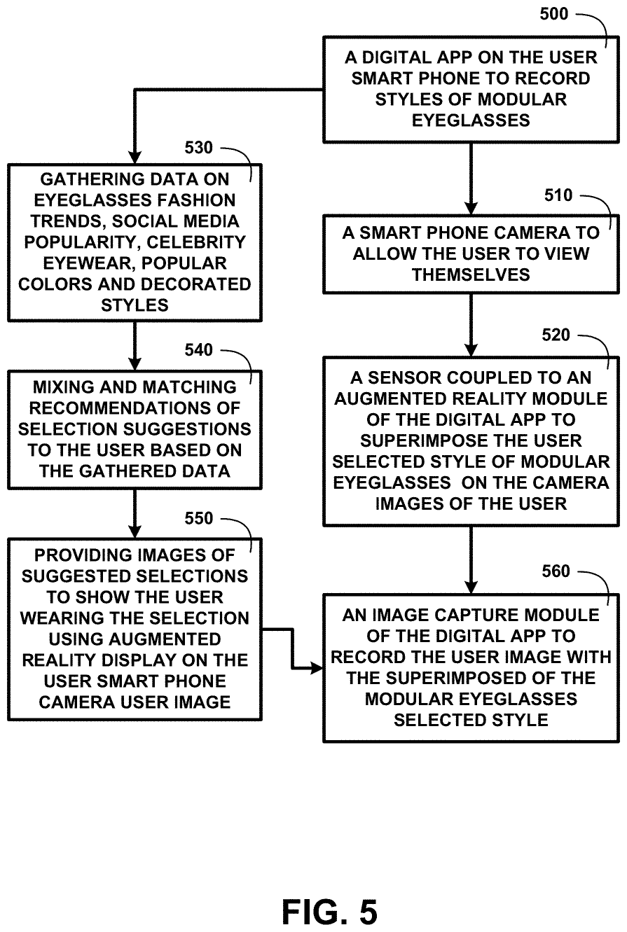

FIG. 5 shows a block diagram of an overview of an augmented reality module of one embodiment. FIG. 5 shows a digital app on the user smart phone to record styles of modular eyeglasses 500. A smart phone camera allows the user to view themselves 510. A sensor coupled to an augmented reality module of the digital app to superimpose the user selected style of modular eyeglasses on the camera images of the user 520.

Gathering data on eyeglasses fashion trends, social media popularity, celebrity eyewear, popular colors and decorated styles 530. Mixing and matching recommendations of selection suggestions to the user based on the gathered data 540. Providing images of suggested selections to show the user wearing the selection using augmented reality display on the user smart phone camera user image 550. An image capture module of the digital app to record the user image with the superimposed of the modular eyeglasses selected style 560 of one embodiment.

### Right Arm:

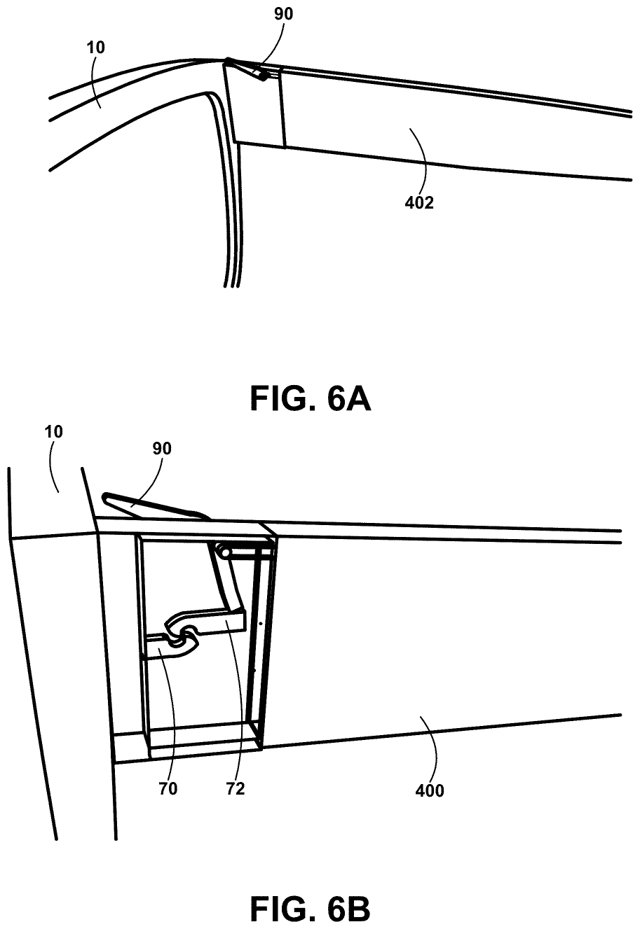

FIG. 6A shows for illustrative purposes only an example of a right arm of one embodiment. FIG. 6A shows the frame 10 and lever 90 of the style no. 1 right arm 402 of one embodiment.

### Left Arm Hooks:

FIG. 6B shows for illustrative purposes only an example of left arm hooks of one embodiment. FIG. 6B shows the frame 10 and lever 90 of the style no. 1 left arm 400 with the frame hook 70 and arm hook 72 exposed for illustrative purposes. In this view the hooks are not engaged of one embodiment.

### Left Arm Hooks Unengaged:

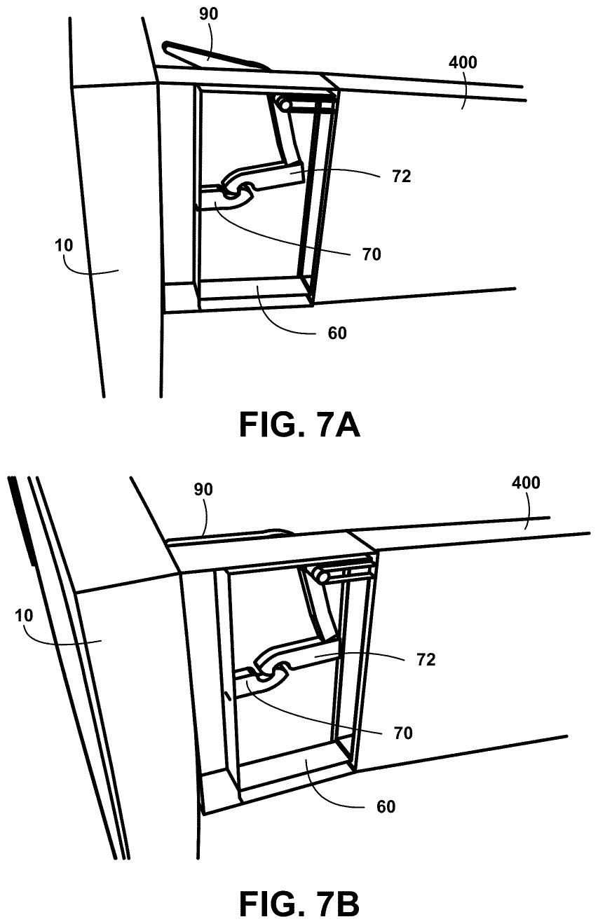

FIG. 7A shows for illustrative purposes only an example of left arm hooks unengaged of one embodiment. FIG. 7A shows the frame 10 and lever 90 of the style no. 1 left arm 400. In this view the frame hook 70 and arm hook 72 are unengaged within the male portion 60. The male portion 60 inserts into the hinged section of the frame 10 of one embodiment.

### Left Arm Hooks Engaged:

FIG. 7B shows for illustrative purposes only an example of left arm hooks engaged of one embodiment. FIG. 7B shows the frame 10 and lever 90 of the style no. 1 left arm 400. In this view the lever 90 is fully down to cause the frame hook 70 and arm hook 72 to be engaged within the male portion 60. The male portion 60 inserts into the hinged section of the frame 10 in of one embodiment.

### Find My Glasses App:

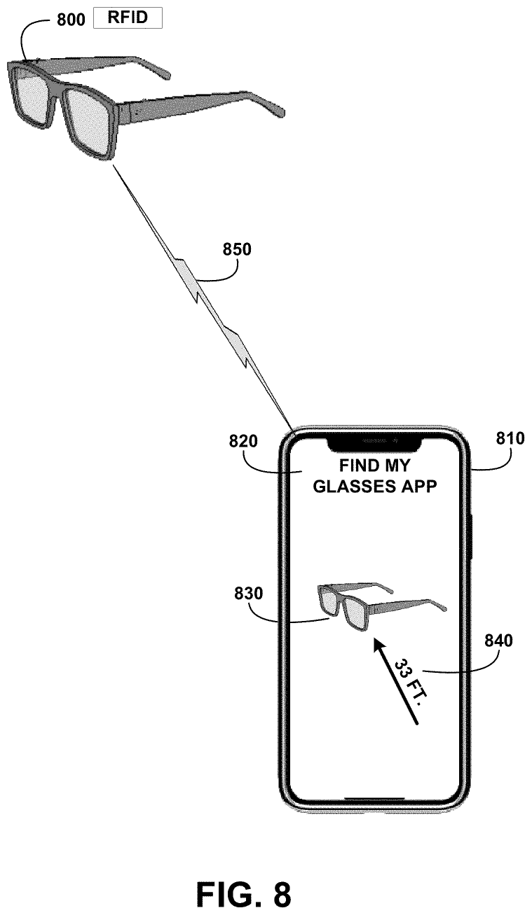

FIG. 8 shows for illustrative purposes only an example of a find my glasses app of one embodiment. FIG. 8 shows radio-frequency identification (RFID) 800 devices coupled to the style no. 1 left arm 400 of FIG. 4. A user smart phone 810 is installed with a find my glasses app 820 installed. The find my glasses app 820 displays on the smart phone 810 an image of the user modular eyeglasses 830. The RFID 800 data displays a distance and direction relative to the position of the smart phone pointing to the user modular eyeglasses 840. The RFID 800 updates the distance and direction as the user moves toward the user modular eyeglasses 850 of one embodiment. The find my glasses app 820 may include interconnected sensors and devices modules

The interconnected sensors and devices modules may include wireless digital sensors and digital electronics and communication devices are configured to create interconnected sensors and devices modules. The interconnected sensors and devices modules are positioned in predetermined numbers and spacing. Wireless digital sensors and digital electronics and communication devices may include at least a smartphone 3-dimensional coordinate system. Based on this system, sensors in your smartphone detect and record changes in real-time.

Motion sensors detect the movement, acceleration, and rotation along the three axes of the device's coordinate system. Some examples of motion sensors are accelerometers, gravity sensors, and gyroscopes. An accelerometer records the movement of your device along the three axes of the coordinate system. The X-axis measures the movement of your device from side to side, the Y-axis measures the movement along top and bottom (including gravity), and the Z-axis measures the movement forward and backward.

A gyroscope measures the rotation along the three axes of the device's coordinate system. It detects the exact measure of your phone's rotation in radians per second. Position sensors record the physical location of the device. They do this by identifying your phone's coordinates—taking the world around them as a frame of reference and its orientation in 3-dimensional space. Phones use them for navigation, detecting screen orientation, and much more. Examples of position sensors are proximity sensors, GPS, and magnetometers.

A magnetometer senses your phone's orientation according to the earth's magnetic field. This sensor is essential to navigation and compass apps as it helps your phone identify directions and adjust the map accordingly. A Global Positioning System (GPS) is a sensor with antennas to help navigation. It receives continuous signals from satellites that help calculate the distance traveled and the location of your phone. Environmental sensors detect any significant changes in the surroundings of your smartphone. For example, these include changes in the lighting, pressure, temperature; adjusting the brightness when the auto-brightness is enabled, display temperature, measuring air pressure, and more.

Examples of environmental sensors are ambient light sensors, thermometers, barometers, air-humidity sensors, etc. Ambient light sensors measure the intensity of light around the device. These sensors detect the changes in brightness of the surroundings and record its intensity. Proximity sensors detect how close a certain object is to your phone. A quick example of this is your phone's display turning off when you pick up and answer a call. This helps save battery charge and avoids accidental taps during phone calls. A Hall sensor is quite similar to a proximity sensor, except it detects changes in the magnetic fields around the device. When it senses a change in the magnetic field, it sends this data to the processor, turning off the phone's display. This sensor is specifically used to detect the magnets in flip covers.

In this example, proximity sensors work by measuring the distance between the screen and your ear, and when the distance equals a set value, it turns off the display before your ear touches the screen. Biometric sensors use physical attributes for identification and are typically used for security purposes. As physical features like fingerprints, irises, and faces are unique to a person, using them for identity authentication provides enhanced protection. Some of the biometric sensors are Fingerprint Scanner and Iris Sensor. Atmospheric sensors detect several aspects of your device's surrounding like atmospheric pressure, ambient temperature, air humidity, etc. Atmospheric sensors include Thermometer, Barometer and Air humidity sensors of one embodiment.

Vision and Imaging Sensors/Detectors are electronic devices that detect the presence of objects or colors within their fields of view and convert this information into a visual image for display. Temperature Sensors/Detectors/Transducers are electronic devices that detect thermal parameters and provide signals to the inputs of control and display devices. Radiation Sensors/Detectors are electronic devices that sense the presence of alpha, beta, or gamma particles and provide signals to counters and display devices. Proximity Sensors are electronic devices used to detect the presence of nearby objects through non-contacting means.

Pressure Sensors/Detectors/Transducers are electro-mechanical devices that detect forces per unit area in gases or liquids and provide signals to the inputs of control and display devices. Position Sensors/Detectors/Transducers are electronic devices used to sense the positions of valves, doors, throttles, etc. and supply signals to the inputs of control or display devices. Photoelectric sensors are electrical devices that sense objects passing within their field of detection, although they are also capable of detecting color, cleanliness, and location if needed.

Particle Sensors/Detectors are electronic devices used to sense dust and other airborne particulates and supply signals to the inputs of control or display devices. Motion Sensors/Detectors/Transducers are electronic devices that can sense the movement or stoppage of parts, people, etc. and supply signals to the inputs of control or display devices. Metal Detectors are electronic or electro-mechanical devices used to sense the presence of metal in a variety of situations ranging from packages to people. Level Sensors/Detectors are electronic or electro-mechanical devices used for determining the height of gases, liquids, or solids in tanks or bins and providing signals to the inputs of control or display devices.

Leak Sensors/Detectors are electronic devices used for identifying or monitoring the unwanted discharge of liquids or gases. Humidity Sensors/Detectors/Transducers are electronic devices that measure the amount of water in the air and convert these measurements into signals that can be used as inputs to control or display devices. Gas and Chemical Sensors/Detectors are fixed or portable electronic devices used to sense the presence and properties of various gases or chemicals and relay signals to the inputs of controllers or visual displays. Force Sensors/Transducers are electronic devices that measure various parameters related to forces such as weight, torque, load, etc. and provide signals to the inputs of control or display devices. A force sensor typically relies on a load cell, a piezoelectric device whose resistance changes under deforming loads.

Flow Sensors/Detectors are electronic or electro-mechanical devices used to sense the movement of gases, liquids, or solids and provide signals to the inputs of control or display devices. Flaw Sensors/Detectors are electronic devices used in a variety of manufacturing processes to uncover inconsistencies on surfaces or in underlying materials such as welds. Flame Detectors are optoelectronic devices used to sense the presence and quality of fire and provide signals to the inputs of control devices. Electrical Sensors/Detectors/Transducers are electronic devices that sense current, voltage, etc. and provide signals to the inputs of control devices or visual displays. Non-contact sensors are devices that do not require a physical touch between the sensor and the object being monitored in order to function.

Infrared sensors use infrared light in various forms. Some detect the infrared radiation emitted by all objects. Others cast infrared beams that are reflected back to sensors that look for interruptions of the beams. Temperature sensors generally rely on RTDs or thermistors to sense changes in temperature through the change in electrical resistance that occurs in materials. Non-contacting proximity sensors often use the Hall Effect phenomena, eddy currents, or capacitive effects to detect the nearness of conductive metals. Other methods are used as well, including optical and laser. Where proximity sensors can be used to detect small changes in the positions of targets, simple on/off proximity switches use the same methods to detect, for instance, an open door.

Ultrasonic sensors measure the time between the emission and reception of ultrasonic waves to determine the distance to a tank's contents, for example. In another form, ultrasonic sensors detect the ultrasonic energy emitted by leaking air, etc. Force and pressure sensors typically use strain gages or piezoelectric devices which change their resistance characteristics under applied loads. These changes can be calibrated over the linear ranges of the transducers to produce measures of weight (force) or pressure (force per unit area). Vision sensors typically rely on CCD, infrared, or ultraviolet cameras to produce images that can be interpreted by software systems to detect flaws, sense barcodes, etc. of one embodiment.

Encoders are electromechanical devices that are used to convert linear or rotary motions to analog or digital output signals. Load Cells are mechanical or electronic devices designed to convert forces including compressive, tensile, torsional, or shear, into electrical signals. Monitors are typically electronic devices used to remotely or conveniently view information as required. Data Acquisition Systems (abbreviated DAQ or DAS) collect analog signals from sensors measuring real-world samples and transduce them into digital formats that are processed by data loggers. Data Loggers are electronic data storage devices used to gather and record various data-over-time measurements. Digital switches are electromechanical devices that are used in electrical circuits. Thermocouples are mechanical devices formed of dissimilar metal wires welded together and used for the measurement of temperature of one embodiment.

### Trigger Connector:

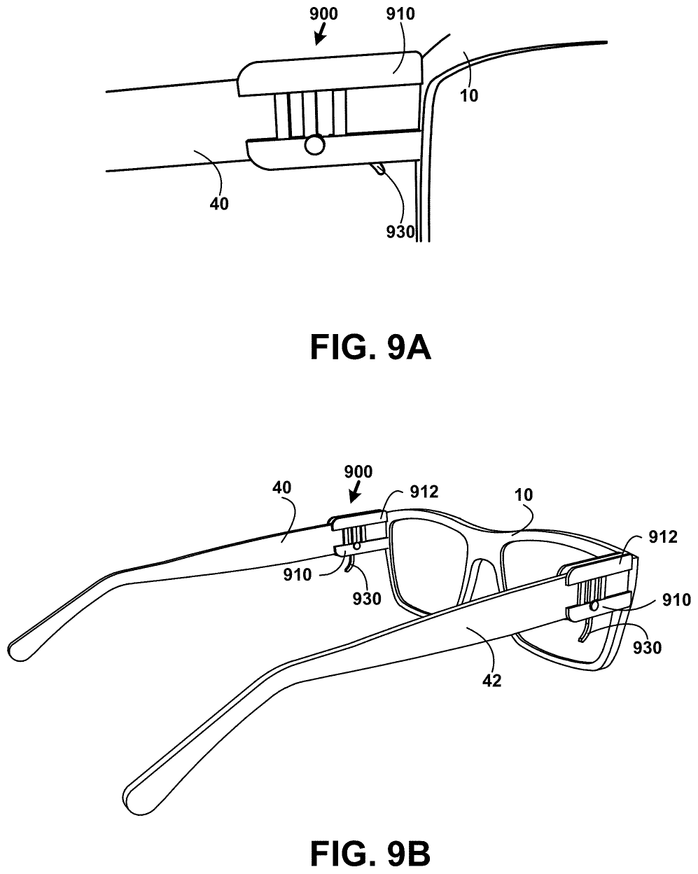

FIG. 9A shows for illustrative purposes only an example of a trigger connector of one embodiment. FIG. 9A shows a male portion coupled to the hinged frame 10 section 900. A trigger connector 910 shows an embodiment of a trigger 930 in an illustration of a section of an arm 40 with the trigger exposed 940 in the locked position of one embodiment.

### Trigger Connector Installed:

FIG. 9B shows for illustrative purposes only an example of a trigger connector installed of one embodiment. FIG. 9B shows a trigger connector 910 coupled to a frame hinged section 912 of the frame 10. Both the left arm 40 and the right arm 42 Include an embodiment of a trigger 930 of one embodiment.

### Trigger Connector Hooks Engaged:

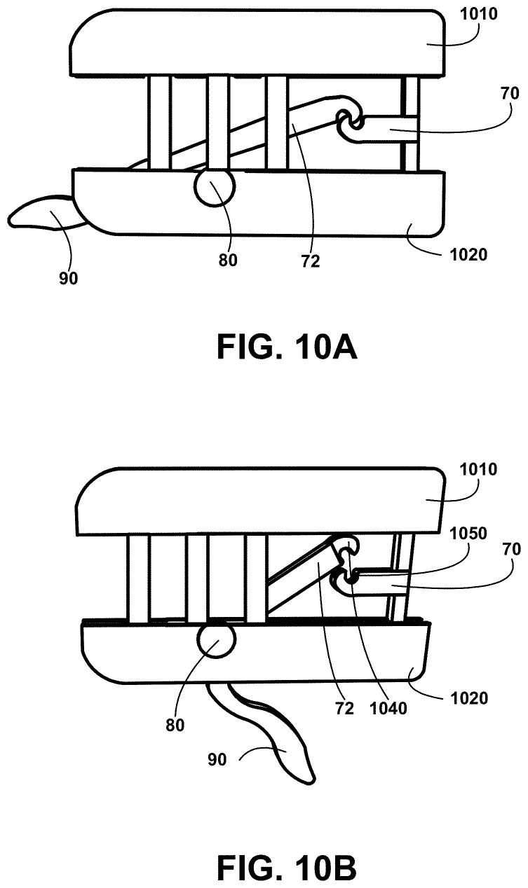

FIG. 10A shows for illustrative purposes only an example of trigger connector hooks engaged of one embodiment. FIG. 10A shows the frame hook 70 and arm hook 72 engaged. The pivot point 80 is where the lever pin is used to rotate the lever 90. The trigger connector includes a top arm guide 1010 and a bottom arm guide 1020 between which the arm is inserted of one embodiment.

### Trigger Connector Hooks Unengaged:

FIG. 10B shows for illustrative purposes only an example of trigger connector hooks unengaged of one embodiment. FIG. 10B shows the frame hook 70 and arm hook 72 unengaged. The arm hook is lifted to be unengaged 1040 from the frame hook stationary 1050 position. The pivot point 80 is where the lever pin is used to rotate the lever 90. The trigger connector includes a top arm guide 1010 and a bottom arm guide 1020 between which the arm is inserted of one embodiment.

### Trigger Connector:

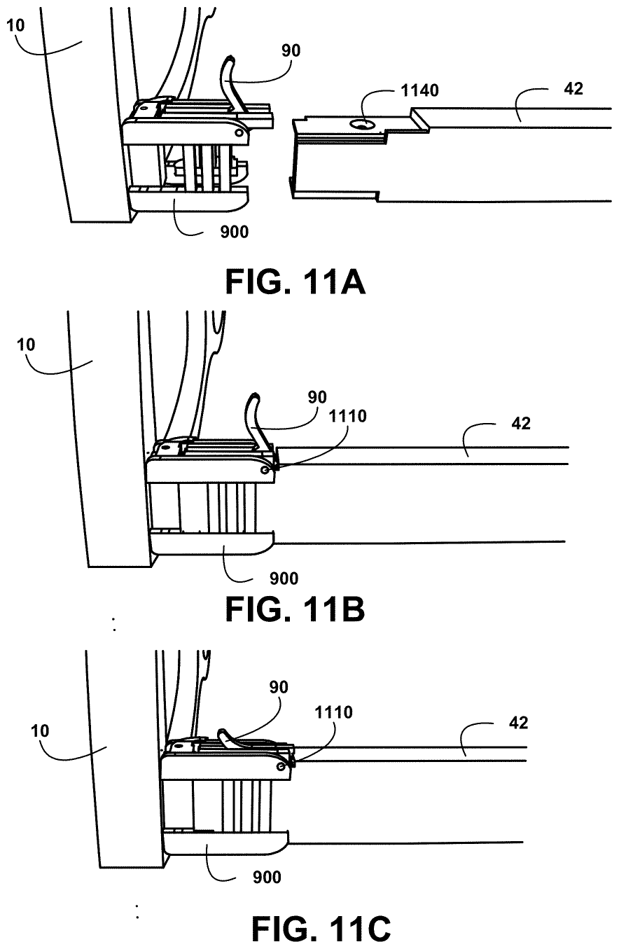

FIG. 11A shows for illustrative purposes only an example of a trigger connector of one embodiment. FIG. 11A shows the lever 90 in an unlocked position in the hinged frame section 900. The right arm 42 is retracted and a dimple 1140 to receive the lever 90 for a friction connection. The frame 10 is connected to the hinged frame section 900. The right arm 42 is positioned for insertion into the hinged frame section 900 guided by the recesses of one embodiment.

### Example of Levers:

FIG. 11B shows for illustrative purposes only an example of levers of one embodiment. FIG. 11B shows a lever pivot pin 1110 upon which the lever is rotated. The right arm 42 has been inserted into the hinged frame section 900 connected to the frame 10 of one embodiment.

### Arm Section:

FIG. 11C shows for illustrative purposes only an example of an arm section of one embodiment. FIG. 11C shows the right arm 42 has been inserted into the hinged frame section 900 connected to the frame 10. The lever 90 is pivoted into a locked position wherein the curved portion of the lever is rotated into contact with the dimple 1140 to prevent unintentional retraction of the right arm 42 of one embodiment.

### Temple Insertion Terminus:

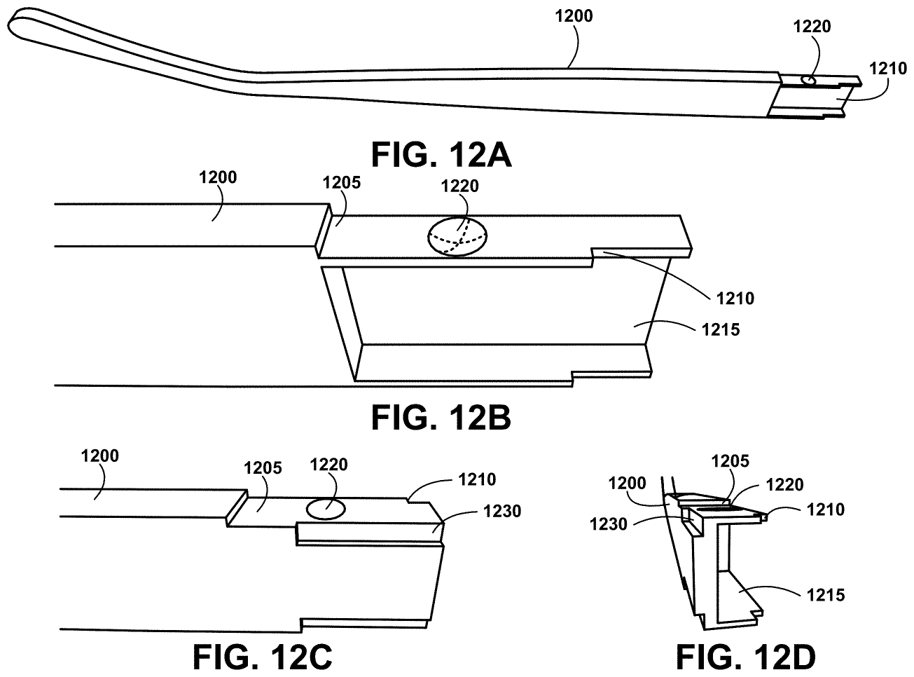

FIG. 12A shows for illustrative purposes only an example of a temple insertion terminus of one embodiment. FIG. 12A shows an eyewear temple 1200 with recesses 1210 for insertion into the hinged frame section 900 of FIG. 9. This embodiment of the temple 1200 includes a dimple 1220 for creating friction when a locking lever is rotated downward to position a curved lever section into the dimple 1220. The dimple friction and elevated edge prevents the temple from slipping prematurely from the eye ware frame of one embodiment. In another embodiment the sockets 80 are coupled to each end of the eyeglasses frame with hinges. The sockets are hollowed and contain removable locking mechanisms. The hollowed section interior dimensions match the exterior reduced dimensions of the distal end insertable section. The distal end insertable section includes a semi-circular recess with a predetermined length and depth. The removable locking mechanisms include a semi-circular curved portion with an extended lever. The lever is exposed in a lifted unlocked position to enable the user to insert the distal end into the hollowed opening of the socket. After insertion the user presses the lever downward to rotate and position the semi-circular curved portion with the same width and length of the recess into the recess. The semi-circular curved portion fills the depth of the recess with pressure being applied to prevent the arm from inadvertently being withdrawn. When the user lifts the lever the semi-circular curved portion is rotated about a pivot pin and disengages from the recess allowing the arm to be withdrawn from the socket.

### Temple Friction Dimple:

FIG. 12B shows for illustrative purposes only an example of a temple friction dimple of one embodiment. FIG. 12B shows the dimple 1220 recess into the temple 1200 material and forming a receiver for the curved lever section when moved into a locking position. The recesses 1205, 1210 and 1215 in the temple allow the temple to insert correctly and readily into the hinged frame section 900 of FIG. 9A. The recesses also align the dimple with the lever of one embodiment.

### Temple Friction Dimple Reverse Side of Temple View:

FIG. 12C shows for illustrative purposes only an example of a temple friction dimple reverse side of temple view of one embodiment. FIG. 12C shows the reverse side of the temple 1200. The side recesses 1230 further align the temple for insertion and maintaining a vertical position of the temple for fitting over the tops of the wearer's ears. Recess 1205 provides a depth distance for the insertion. The recess 1210 allows passage for another portion of the hinged frame section 900 of FIG. 9A of one embodiment.

### Temple Insertion Terminus Profile:

FIG. 12D shows for illustrative purposes only an example of a temple insertion terminus profile of one embodiment. FIG. 12D shows the profile of the temple 1200 with the recesses. The depth of insertion is established with the 1205 recess stop. The dimple 1220 is placed along the recess ledge to match the lever locking position. The top and bottom recess 1210 pass then about another element of the hinged frame section 900 of FIG. 9A creating a stop. The larger recess 1215 provides space for additional elements. The side recesses 1230 on the reverse, guide the temple through the insertion of one embodiment.

Temple Insertion Terminus with a Locking Lever in an Unlocked Position:

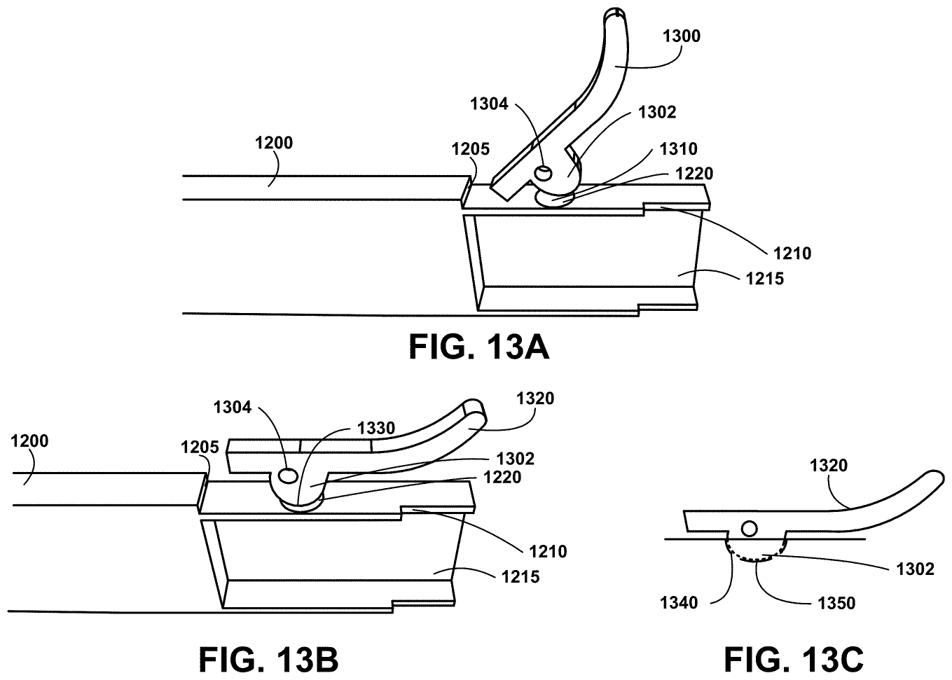

FIG. 13A shows for illustrative purposes only an example of a temple insertion terminus with a locking lever in an unlocked position of one embodiment. FIG. 13A shows another embodiment of the lever 1300 without the balance of the hinged frame section 900 of FIG. 9A elements for illustrative clarity. When the temple 1200 is inserted fully the lever 1300 is in an up unlocked position. The recesses 1205, 1210 and 1215 position the dimple 1220 beneath the curved portion 1302 of the lever 1300. The lever 1300 rotates on a pivot pin inserted through the pivot pin hole 1304 and is secured on other elements. The off center position of the pivot pin hole 1304 rotates the curved portion 1302 to enable the protruding section to contact the bottom of the dimple 1310 of one embodiment.

Temple Friction Dimple with a Locking Lever in a Locked Position

FIG. 13B shows for illustrative purposes only an example of a temple friction dimple with a locking lever in a locked position of one embodiment. FIG. 13B shows the temple 1200, recesses 1205, 1210 and 1215 and dimple 1220. The lever 1320 is shown in a down locked position. The lever 1320 curved portion 1302 pivoting on the pivot pin hole 1304 forces the curved portion 1302 into the dimple 1220 until it presses against the bottom surface 1330 of the dimple 1220. This force creates friction along the bottom surface 1330 and any movement up along the circular surfaces and edge adding to the restriction of movement. The friction and additional restraint prevents the temple 1200 from unintended extraction from the hinged frame section 900 of FIG. 9A of one embodiment.

Temple Friction Dimple Profile with Locked Lever:

FIG. 13C shows for illustrative purposes only an example of a temple friction dimple profile with locked lever of one embodiment. FIG. 13C shows the curved portion 1302 of the lever 1320 point of contact with the dimple profile 1340. The point of contact at the bottom surface of the dimple 1350 develops friction to restrain the temple from unintentional extraction. In the locked position the lever 1200 in the down locked position also presents the curved portion 1302 with an extraction obstacle of the curved surface up from the bottom and the edge of the dimple to avoid unintentional extraction of one embodiment.

Temple Insertion Terminus with a Friction Channel:

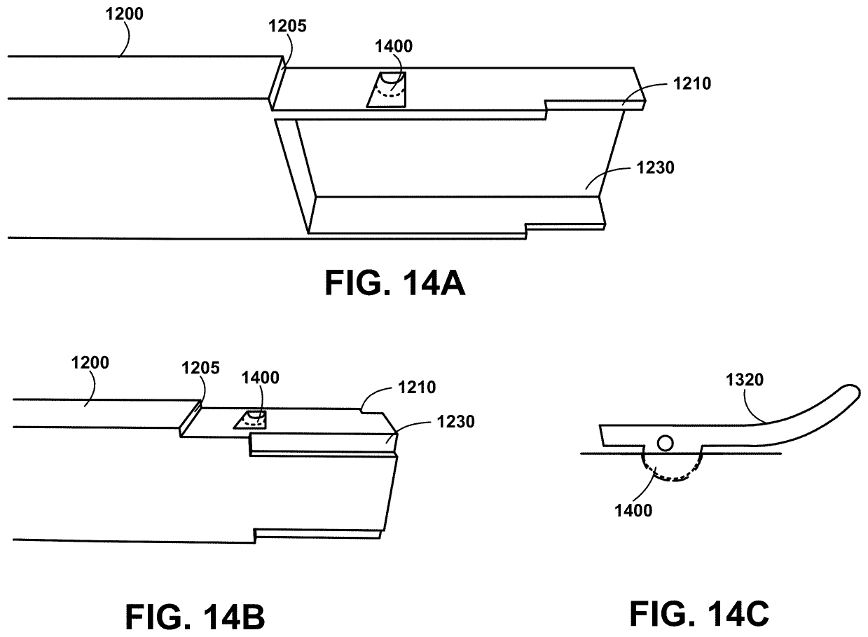

FIG. 14A shows for illustrative purposes only an example of a temple insertion terminus with a friction channel of one embodiment. FIG. 14A shows another embodiment of an unintentional extraction forms as a channel depression 1400. The temple 1200, recesses 1205, 1210 and 1230 align the lever 1320 of FIG. 13 with the channel depression 1400 of one embodiment.

### Right Side Temple Friction Channel Reverse Side of Temple View:

FIG. 14B shows for illustrative purposes only an example of a right side temple friction channel reverse side of temple view of one embodiment. FIG. 14B shows the temple 1200, recesses 1205, 1210 and 1230 on the reverse side. The channel depression 1400 presents the lever 1320 of FIG. 13 with a receptacle for the curved portion 1302 of one embodiment.

Temple Friction Channel Profile with Locked Lever:

FIG. 14C shows for illustrative purposes only an example of a temple friction channel profile with locked lever of one embodiment. FIG. 14C shows the lever 1320 in a locked position making contact with the bottom surface of the channel depression 1400. The force exerted by the curved portion 1302 of FIG. 13 causes friction to restrain movement of the temple to prevent unintended extraction. The curved depression walls further create an obstacle to restrain unintended extraction of one embodiment.

The foregoing has described the principles, embodiments and modes of operation of the present invention. However, the invention should not be construed as being limited to the particular embodiments discussed. The above described embodiments should be regarded as illustrative rather than restrictive, and it should be appreciated that variations may be made in those embodiments by workers skilled in the art without departing from the scope of the present invention as defined by the following claims.

What is claimed is:

1. A modular eyeglasses apparatus, comprising:
at least one temple interchangeably lockable to at least one eyeglasses frame end, wherein the at least one temple includes an insertable section at a proximal end;
at least one temple lockable receiver coupled to the at least one eyeglasses frame end;
a lockable lever device coupled to the at least one receiver having an extended lever handle with an angled section in a direction away from the top of the frame at a proximal end and having an oblong section protruding from the lever in a direction towards the top of the frame at a distal end and coupled to the at least one temple lockable receiver with a pivot pin;
wherein the insertable section includes a semi-circular depression with a predetermined depth and length substantially matching a depth and length of an elongated portion of the oblong section;
wherein when the temple is inserted in the temple lockable receiver and lever handle is rotated on the pivot pin toward the temple, the elongated portion engages into the semi-circular depression to lock the temple in an inserted position with the temple lockable receiver; and
wherein when the temple is inserted in the temple lockable receiver and lever handle is rotated on the pivot pin away from the temple, the elongated portion disengages with the semi-circular depression to unlock the temple in an unlocked position with the temple lockable receiver.

2. The modular eyeglasses apparatus of claim 1, further comprising an offset pivot hole in the oblong section configured to present a narrower portion to the depression when unlocked and rotates a wider portion into the depression in a locking position.

3. The modular eyeglasses apparatus of claim 1, wherein the elongated portion of the oblong section extends farther from the pivot pin than a narrower portion that does not reach the semi-circular depression.

4. The modular eyeglasses apparatus of claim 1, wherein the lever device elongated portion matches the predetermined depth and length of the semi-circular depression.

5. The modular eyeglasses apparatus of claim 1, wherein the insertable section is configured with an opening in the top surface shorter in length than the lever handle to allow the lever handle to pivot parallel to the insertable section when pressed downward to lock the lockable lever device and to be pivoted upward to unlock the lockable lever device.

6. The modular eyeglasses apparatus of claim 1, wherein the parallel lowered lever handle exposes a portion of the upward angled section allowing the user to manually contact the upward angled section to lift the handle.

7. The modular eyeglasses apparatus of claim 1, wherein the at least one temple is configured with a downward angled proximal end configured to rest on top of a user's ear.

8. The modular eyeglasses apparatus of claim 1, wherein the at least one temple is configured with a rectangular section extending away from the distal end to a proximal end.

9. The modular eyeglasses apparatus of claim 1, wherein the at least one temple insertable section is configured with exterior dimensions matching the interior dimensions of the receiver opening.

10. A modular eyeglasses apparatus, comprising:
at least one temple interchangeably lockable to at least one eyeglasses frame end, wherein the at least one temple includes an insertable section at a proximal end;
wherein the at least one temple is configured with a right side and a left side mirrored form;
at least one temple lockable receiver coupled to the at least one eyeglasses frame end;
a lockable lever device coupled to the at least one receiver having an extended lever handle with an angled section in a direction away from the top of the frame at a proximal end and having an oblong section protruding from the lever in a direction towards the top of the frame at a distal end and coupled to the at least one temple lockable receiver with a pivot pin;
wherein the insertable section includes a semi-circular depression with a predetermined depth and length substantially matching a depth and length of an elongated portion of the oblong section;
wherein when the temple is inserted in the temple lockable receiver and lever handle is rotated on the pivot pin toward the temple, the elongated portion engages into the semi-circular depression to lock the temple in an inserted position with the temple lockable receiver; and
wherein when the temple is inserted in the temple lockable receiver and lever handle is rotated on the pivot pin away from the temple, the elongated portion disengages with the semi-circular depression to unlock the temple in an unlocked position with the temple lockable receiver.

11. The modular eyeglasses apparatus of claim 10, wherein an offset hole pivots the oblong section to present a narrower portion to the depression when unlocked and rotates the elongated portion into the depression in a locking position.

12. The modular eyeglasses apparatus of claim 10, wherein the at least one temple insertable section is configured with exterior dimensions matching the interior dimensions of the receiver opening.

13. The modular eyeglasses apparatus of claim 10, wherein the at least one temple is configured with an angled proximal end configured to rest on top of a user's ear.

14. The modular eyeglasses apparatus of claim 10, wherein the receiver is configured with an opening in the surface of the receiver away from the top of the frame and is shorter in length than the lever handle to allow the lever handle to pivot parallel to the receiver when pressed towards the receiver to lock the temple in place and to be pivoted away from the receiver to unlock the temple for withdrawal.

15. A method of modular eyeglasses, comprising:
providing at least one temple interchangeably lockable to at least one eyeglasses frame end, wherein the at least one temple includes an insertable section at a proximal end;
matching the at least one temple insertable section exterior dimensions to a receiver interior opening dimensions to insert the at least one temple into the receiver;
providing at least one temple lockable receiver coupled to the at least one eyeglasses frame end;
providing a lockable lever device coupled to the at least one receiver having an extended lever handle with an angled section in a direction away from the top of the frame at a proximal end and having an oblong section protruding from the lever in a direction towards the top of the frame at a distal end and coupled to the at least one temple lockable receiver with a pivot pin;
providing a semi-circular depression in the insertable section with a predetermined depth and length substantially matching a depth and length of an elongated portion of the oblong section;
inserting the temple in the temple lockable receiver;
rotating the lever handle on the pivot pin toward the temple, wherein the elongated portion engages into the semi-circular depression to lock the temple in an inserted position with the temple lockable receiver; and
rotating the lever handle on the pivot pin away from the temple, wherein the elongated portion disengages with the semi-circular depression to unlock the temple from the temple lockable receiver for withdrawal.

16. The method of modular eyeglasses of claim 15, wherein the receiver is configured with an opening in the surface of the receiver away from the top of the frame and is shorter in length than the lever handle to allow the lever handle to pivot parallel to the receiver when pressed towards the receiver to lock the temple in place and to be pivoted away from the receiver to unlock the temple for withdrawal.

17. The method of modular eyeglasses of claim 15, wherein the oblong section extends farther from the pivot pin in the elongated portion than other portions in another direction from the pivot pin.

18. The method of modular eyeglasses of claim 15, wherein the at least one temple is configured with a rectangular section extending away from the distal end towards a proximal end.

19. The method of modular eyeglasses of claim 15, further comprising receiving electronic location signals with a digital app from at least one electronic device integrated into the temple to allow a user to find the eyeglasses arms.

20. The method of modular eyeglasses of claim 15, further comprising a plurality of different styles and colors of the interchangeable at least one temple configured to be inserted into the receiver.
